(19) United States
(12) Patent Application Publication
(10) Pub. No.: US 2025/0355318 A1
(43) Pub. Date: Nov. 20, 2025

(54) OPTICAL MEMBER DRIVING MECHANISM

(71) Applicant: TDK CORPORATION, Tokyo (JP)

(72) Inventors: Chuan-Min LEE, Taoyuan City (TW); Shu-Shan CHEN, Taoyuan City (TW); Pai-Jui CHENG, Taoyuan City (TW)

(73) Assignee: TDK CORPORATION, Tokyo (JP)

(21) Appl. No.: 19/207,608

(22) Filed: May 14, 2025

Related U.S. Application Data
(60) Provisional application No. 63/648,834, filed on May 17, 2024.

(51) Int. Cl. G03B 5/00; G02B 7/04; G03B 30/00

(52) U.S. Cl. CPC G03B 5/00; G02B 7/04; G03B 30/00; G03B 2205/0069

(57) ABSTRACT

An optical member driving mechanism is provided. The optical member driving mechanism includes a movable portion, a fixed portion, and a driving assembly. The movable portion is configured to connect an optical member, and the movable portion is movable relative to the fixed portion. The driving assembly is configured to drive the movable portion to move.

### CROSS REFERENCE TO RELATED APPLICATIONS

This application claims the benefit of U.S. Provisional Application No. 63/648,834, filed May 17, 2024, the entirety of which is incorporated by reference herein.

### BACKGROUND OF THE INVENTION

### Field of the Invention

The application relates in general to an optical member driving mechanism, and in particular it relates to an optical member driving mechanism for driving an optical member to move.

### Description of the Related Art

As technology has advanced, a lot of electronic devices (cameras and smartphones, for example) have incorporated the functionality of taking photographs and recording video. These electronic devices have become more commonplace, and have been developed to be more convenient and thin. More and more options are provided for users to choose from.

### BRIEF SUMMARY OF INVENTION

An embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move.

In some embodiments, the fixed portion includes a first surface, a second surface, a first opening, and a second opening. The first surface and the second surface respectively faces a light-entering side and a light-exiting side. The first opening is formed on the first surface, the second opening is formed on the second surface, and the optical axis passes through the first opening and the second opening. The movable portion includes a connecting surface, and the connecting surface faces the optical member. The movable portion is movable relative to the fixed portion in a movement range, and when the movable portion is in the default position, the movable portion is disposed at the center of the movement range. When the movable portion is in the default position, as observed along the optical axis, the shortest distance between the connecting surface and the first surface is different from the shortest distance between the connecting surface and the second surface.

In some embodiments, when the movable portion is in the default position, as observed along the optical axis, the shortest distance between the connecting surface and the first surface is greater than the shortest distance between the connecting surface and the second surface.

In some embodiments, the fixed portion includes a base, the second surface is formed on the base, and the base includes a first depression structure, a first protrusion structure, and a second protrusion structure. The first depression structure is formed on the second surface, and is configured to receive an optical unit. The first protrusion structure protrudes outwardly from the second surface and is adjacent to the first depression structure. The second protrusion structure protrudes outwardly from the second surface and is adjacent to the first protrusion structure. The height of the first protrusion structure protruding from the second surface is greater than the height of the second protrusion structure protruding from the second surface.

In some embodiments, the base further includes a second depression structure, formed on the second surface and configured to receive an electronic member. The second depression structure does not communicate with the first depression structure.

In some embodiments, the base further includes a third protrusion structure protruding outwardly from the second surface, the third protrusion structure surrounds the second opening, and the second protrusion structure is disposed between the first protrusion structure and the third protrusion structure. The height of the third protrusion structure protruding from the second surface is greater than the height of the second protrusion structure protruding from the second surface, and the height of the third protrusion structure protruding from the second surface is greater than the height of the first protrusion structure protruding from the second surface.

In some embodiments, as observed along a direction that is parallel to the second surface, the driving assembly overlaps the second surface, the driving assembly overlaps the first protrusion structure, the driving assembly overlaps the second protrusion structure, and the driving assembly overlaps the third protrusion structure.

In some embodiments, the base further includes a fourth protrusion structure protruding outwardly from the second surface, and at least a portion of the driving assembly is disposed in the fourth protrusion structure.

In some embodiments, the base further includes a third surface and a third depression structure. The third surface and the second surface face opposite directions. The third depression structure is formed on the third surface and corresponds to the movable portion or the optical member. As observed along a direction that is perpendicular to the third direction, the third depression structure overlaps the second protrusion structure, and the third depression structure overlaps the first protrusion structure.

In some embodiments, the driving assembly includes a driving source, the driving source is configured to generate a driving force, and as observed along a direction that is perpendicular to the optical axis, the shortest distance between the driving source and the first surface is less than the shortest distance between the driving source and the second surface.

In some embodiments, the driving assembly further includes a transferring member, the transferring member is configured to transfer the driving force, and as observed along the direction that is perpendicular to the optical axis, the driving source is disposed between the transferring member and the first surface.

In some embodiments, the driving assembly further includes an amplifying member, the amplifying member is configured to amplify the driving force, and as observed along the direction that is perpendicular to the optical axis, the amplifying member is disposed between the driving source and the first surface.

In some embodiments, the fixed portion includes a fourth surface and a fifth surface, the fourth surface faces the driving assembly, the fifth surface faces the driving assembly, and the fourth surface and the fifth surface face different directions, wherein the driving assembly has a longitudinal structure, the fourth surface is not parallel to an extending direction of the longitudinal structure, and the shortest distance between the driving assembly and the fourth surface is different from the shortest distance between the driving assembly and the fifth surface.

In some embodiments, the shortest distance between the driving assembly and the fourth surface is less than the shortest distance between the driving assembly and the fifth surface, and the amplifying member is disposed between the fourth surface and the driving source.

In some embodiments, the shortest distance between the fifth surface and the driving assembly is greater than 0.15 millimeters.

In some embodiments, the relative density of the amplifying member is greater than the relative density of the fixed portion.

In some embodiments, the amplifying member comprises metal, the fixed portion comprises resin, and the relative density of the amplifying member is more than five times the relative density of the fixed portion.

In some embodiments, the optical member driving mechanism further includes a first connecting member and a second connecting member. The first connecting member is disposed on the fourth surface and in contact with the driving assembly. The second connecting member is disposed on the fifth surface and in contact with the driving assembly. The Young's modulus of the first connecting member is less than the Young's modulus of the fixed portion, and the Young's modulus of the first connecting member is less than the Young's modulus of the amplifying member.

In some embodiments, the optical member driving mechanism further includes a first guiding member and a second guiding member. The first guiding member is connected to the fixed portion, and the movable portion is movably connected to the first guiding member. The second guiding member is connected to the fixed portion, and the movable portion is movably connected to the second guiding member. The fixed portion includes a base, the base includes a third opening and a fourth opening, the third opening is formed on the second surface and corresponds to the first guiding member, and the fourth opening is formed on the second surface and corresponds to the second guiding member.

In some embodiments, the fixed portion includes a frame and a base, the frame and the base are engaged with each other, and the driving assembly is affixed to the frame, wherein the driving assembly includes a circuit board and a wire, the circuit board is disposed on the base, the wire passes through the gap between the frame and the base and connects to the circuit board and the driving assembly.

### BRIEF DESCRIPTION OF DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic diagram of an optical member driving mechanism disposed on an electronic device according to an embodiment of the invention;

FIG. 2 is a schematic diagram of the optical member driving mechanism according to an embodiment of the invention;

FIG. 3 is an exploded-view diagram of the optical member driving mechanism according to an embodiment of the invention;

FIG. 4 is a cross-sectional view taken along the line A-A in FIG. 2;

FIG. 5 is a cross-sectional view taken along the line B-B in FIG. 2;

FIG. 6 is a schematic diagram of the optical member driving mechanism in another view according to an embodiment of the invention;

FIG. 7 is a cross-sectional view taken along the line C-C in FIG. 2; and

FIG. 8 is a partial enlarged diagram of the optical member driving mechanism according to an embodiment of the invention.

### DETAILED DESCRIPTION OF INVENTION

The making and using of the embodiments of the optical member driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The following disclosure provides many different embodiments, or examples, for implementing different features of the subject matter provided. Specific examples of solutions and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

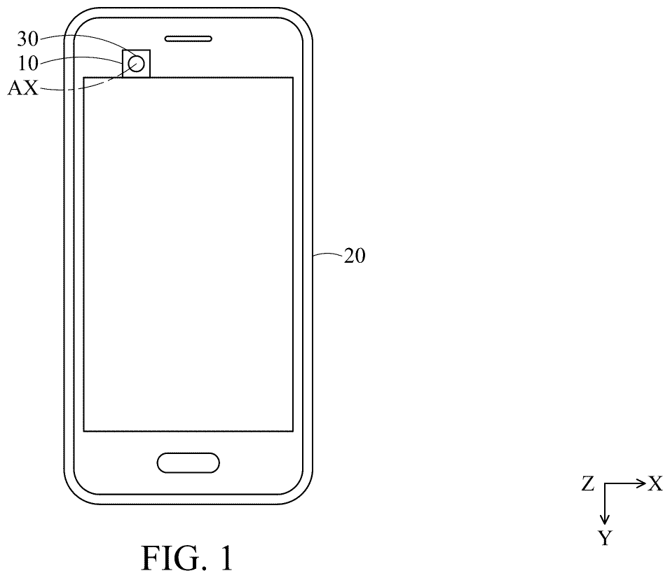

Referring to FIG. 1, an optical member driving mechanism 10 according to an embodiment of the invention can be disposed in an electronic device 20. The optical member driving mechanism 10 can be configured to hold and drive an optical member 30, so that the optical member 30 can move along the optical axis AX of the optical member driving mechanism 10 relative to an image sensor (not shown) in the electronic device 20, and the purpose of focusing, zooming, and/or optical image stabilization (OIS) can be achieved. For example, the electronic device 20 can be a smartphone, a tablet computer, or a digital camera, and the optical member 30 can be a camera lens with a plurality of lenses, but it is not limited thereto.

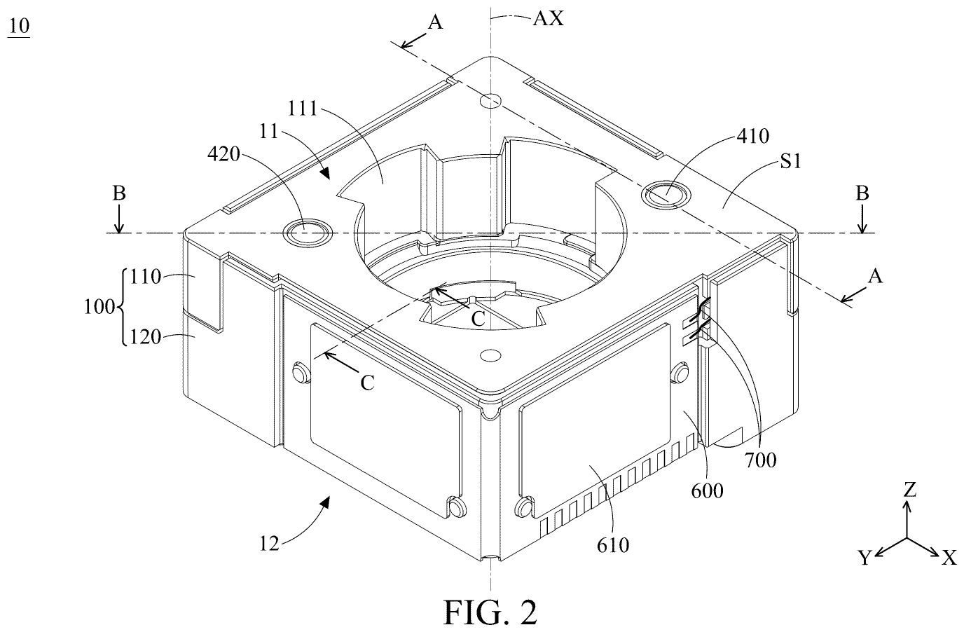

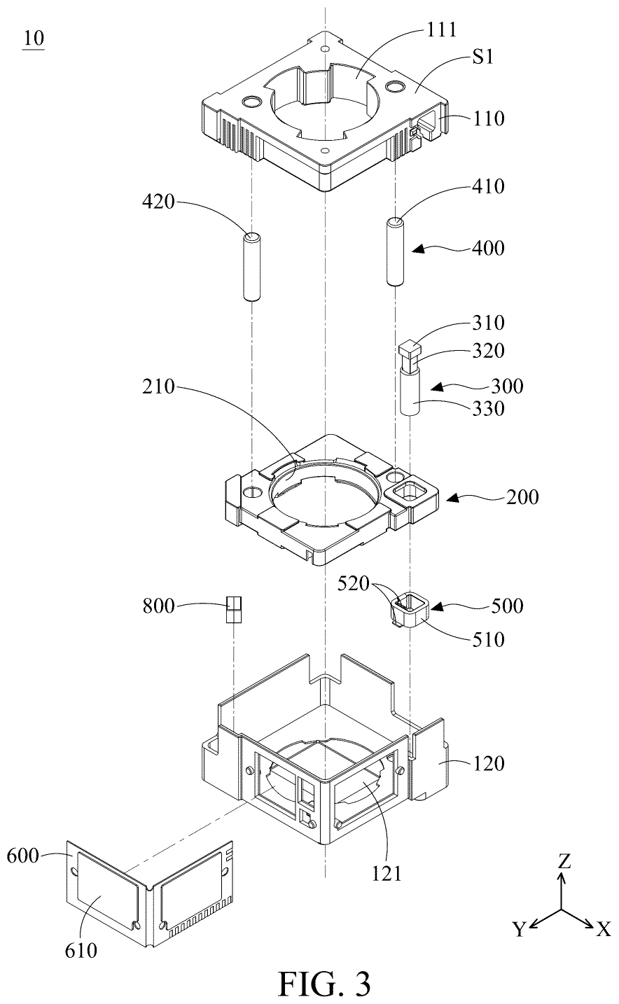

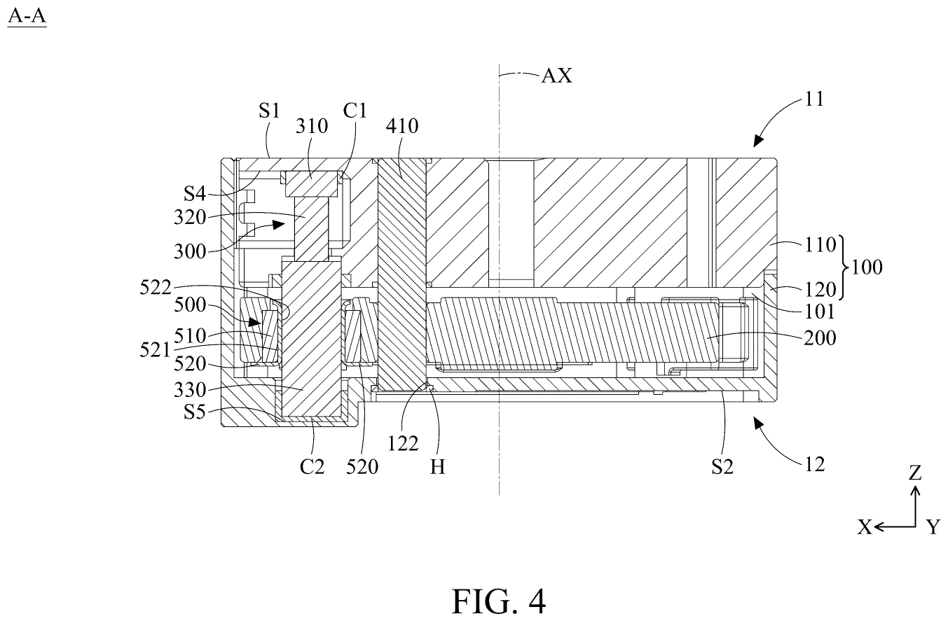

FIG. 2 is a schematic diagram of the optical member driving mechanism 10, FIG. 3 is an exploded-view diagram of the optical member driving mechanism 10, and FIG. 4 is a cross-sectional view taken along the line A-A in FIG. 2. As shown in FIG. 2 to FIG. 4, the optical member driving mechanism 10 primarily includes a fixed portion 100, a movable portion 200, a driving assembly 300, a guiding assembly 400, and a clamping assembly 500.

The fixed portion 100 includes a frame 110 and a base 120, and the frame 110 and the base 120 can be engaged with each other to form an accommodating space 101 therebetween. The movable portion 200, the driving assembly 300, and the guiding assembly 400 can be accommodated in the accommodating space 101, so that they can be protected by the fixed portion 100. The driving assembly 300 is affixed to the frame 110, and the movable portion 200 is movably connected to the driving assembly 300. Therefore, the driving assembly 300 can provide a driving force to the movable portion 200, and the movable portion 200 can move relative to the fixed portion 100.

In detail, the driving assembly 300 includes an amplifying member 310, a driving source 320, and a transferring member 330. The amplifying member 310, the driving source 320, and the transferring member 300 can be arranged along a direction that is parallel to the optical axis AX, so that the driving assembly 300 can include a longitudinal structure extending along the direction that is parallel to the optical axis AX. The frame 110 of the fixed portion 100 has a first surface S1 and a fourth surface S4. The first surface S1 faces a light-entering side 11 of the optical member driving mechanism 10, the fourth surface S4 faces the driving assembly 300 and is opposite to the first surface S1, and the first surface S1 and the fourth surface S4 are substantially perpendicular to the extending direction of the driving assembly 300. The amplifying member 310 can be affixed to the fourth surface S4 of the frame 110 by a first connecting member C1. The driving source 320 is connected to the amplifying member 310, and the amplifying member 310 is disposed between the driving source 320 and the first surface S1 as observed along a direction that is perpendicular to the optical axis AX. The transferring member 330 is connected to the driving source 320, and the driving source 320 is disposed between the transferring member 330 and the first surface S1 as observed along the direction that is perpendicular to the optical axis AX. The shortest distance between the driving source 320 and the first surface S1 of the frame 110 facing the light-entering side 11 is less than the shortest distance between the driving source 320 and a second surface S2 of the base 120 facing the light-exiting side 12.

The driving source 320 includes a piezoelectric member. When the current flows through the driving source 320, the length of the driving source 320 in the direction that is parallel to the optical axis AX is changed. Thus, a driving force can be provided to the transferring member 330 that is connected to the driving source 320. The transferring member 330 can be movably connected to the movable portion 200 by the clamping assembly 500. Therefore, when the driving source 320 provides the driving force to the transferring member 330, the transferring member 330 can transfer the driving force to the movable portion 200 to drive the movable portion to move relative to the fixed portion 100.

In this embodiment, the clamping assembly 500 includes a flexible member 510 and one or more metal sheet spring 520. The flexible member 510 surrounds the transferring member 330, and can be in contact with the movable portion 200 and the outer surface 521 of the metal sheet spring 520. The metal sheet spring 520 can be disposed between the flexible member 510 and the transferring member 330, and the inner surface 522 of the metal sheet spring 520 can be in contact with the transferring member 330. Therefore, when the driving assembly 300 is not working, it can be ensured that the clamping assembly 500 is clamped on the transferring member 330, and the movable portion 200 that is connected to the clamping assembly 500 can be positioned at a desired position. When the driving assembly 300 is working, the metal sheet spring 520 can reduce the friction between the metal sheet spring 520 and the transferring member 330, and prevent the dust from falling into the accommodating space 101 and/or the optical member driving mechanism 10 from failing. In this embodiment, the flexible member 510 can include rubber or silicone gel, but it is not limited thereto.

The amplifying member 310 is configured to amplify the driving force provided by the driving source 320. In particular, the relative density of the amplifying member 310 is greater than the relative density of the frame 110 and the base 120, and is also greater than the relative density of the transferring member 330. For example, the relative density of the amplifying member 310 can be more than five times the relative density of the frame 110 and the base 120. In this embodiment, the amplifying member 310 can include metal, the frame 110 and the base 120 can include resin, and the transferring member 330 can include carbon fibers.

For ensuring that the driving assembly 300 can have sufficient space to deform, the shortest distance between the driving assembly 300 and the fourth surface S4 of the frame 110 facing the driving assembly 300 is less than the shortest distance between the driving assembly 300 and a fifth surface S5 of the base 120 facing the driving assembly 300. In this embodiment, the shortest distance between the driving assembly 300 and the fourth surface S4 is close to zero (that is, the driving assembly 300 can be in contact with the fourth surface S4), and the shortest distance between the driving assembly 300 and the fifth surface S5 is greater than 0.15 millimeters.

Moreover, a second connecting member C2 can be filled between the driving assembly 300 and the fifth surface S5. The first connecting member C1 and the second connecting member C2 can be soft glue. In other words, the fourth surface S4 has a soft material that is in contact with one end of the driving assembly 300 disposed thereon, and the fifth surface S5 have a soft material that is in contact with the other end of the driving assembly 300 disposed thereon. Therefore, the driving assembly 300 can be stable during the operation. It should be noted that, the Young's modulus of the first connecting member C1 and the second connecting member C2 are less than the Young's modulus of the fixed portion 100 and the amplifying member 310, so as to prevent the driving effect of the driving assembly 300 from affecting.

The movable portion 200 can be connected to the optical member 30. Thus, when the driving assembly 300 drives the movable portion 200 to move, the optical member 300 moves accordingly. The movable portion 200 has a connecting surface 210, which faces and connects to the optical member 30.

A first opening 111 is formed on the first surface S1 of the frame 110 of the fixed portion 100 facing the light-entering side 11. A second opening 121 is formed on the second surface S2 of the base 120 of the fixed portion 100 facing the light-exiting side 12. The positions of the first opening 111 and the second opening 121 correspond to the position where the optical member 30 is assembled. Therefore, the external light can enter the first opening 111 via the light-entering side 11, pass through the optical member 30 and the second opening 121 in sequence, and then leaves the optical member driving mechanism 10 from the light-exiting side 12.

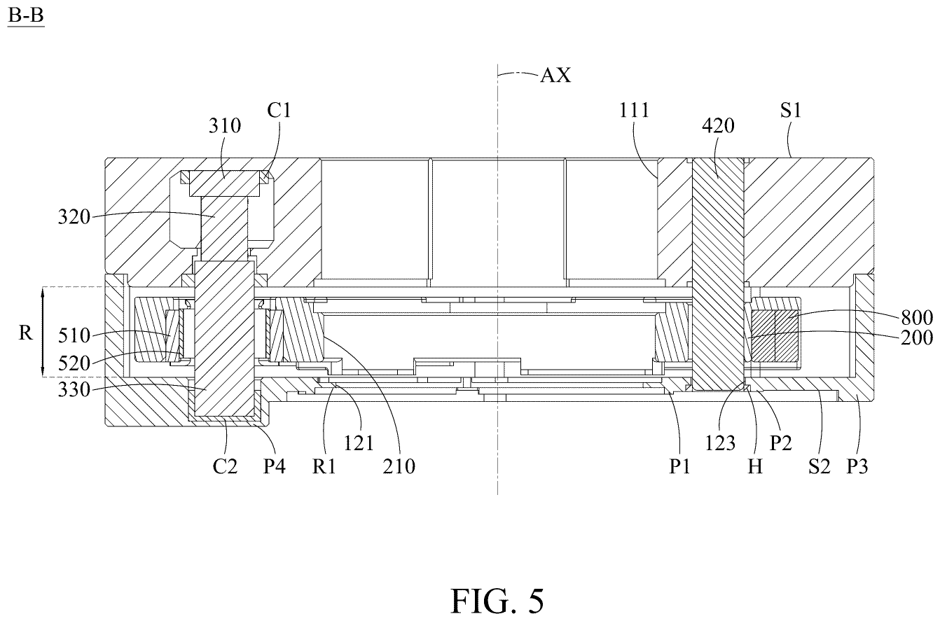

As shown in FIG. 3 and FIG. 5, the movable portion 200 is movable relative to the fixed portion 100 in a movement range R. When the movable portion 200 is situated at the center of the movement range R, it can be defined as being in the default position. At this time, as observed along the direction that is perpendicular to the optical axis AX, the shortest distance between the connecting surface 210 and the first surface S1 is greater than the shortest distance between the connecting surface 210 and the second surface S2.

Owing to the aforementioned structure of the optical member driving mechanism 10, the optical member 30 with any back focal length can be assembled on the optical member driving mechanism 10. In other words, even if the optical member 30 has a large back focal length, it will not be unable to assemble due to the limitation of the structure of the optical member driving mechanism 10 and/or not exceed the thickness of the optical member driving mechanism 10 and cause the dimensions of the optical member driving mechanism 10 to increase.

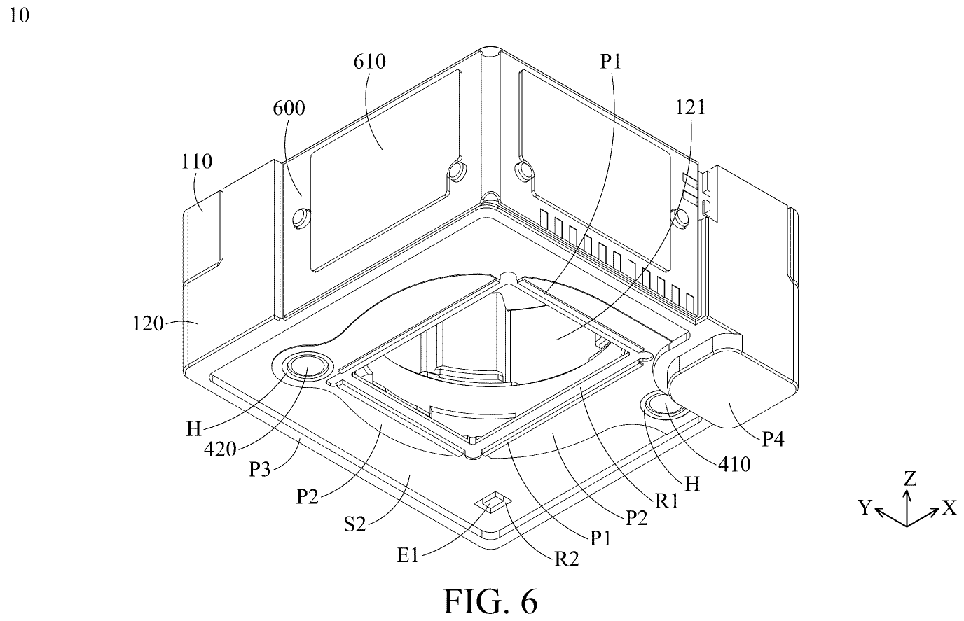

Referring to FIG. 4 to FIG. 6, a first depression structure R1, a second depression structure R2, at least one first protrusion structure P1, at least one second protrusion structure P2, a third protrusion structure P3, and a fourth protrusion structure P4 are formed on the second surface S2 of the base 120.

The first depression structure R1 is configured to receive an optical unit, such as a filter. The first protrusion structure P1 protrudes outwardly from the second surface S2 and is adjacent to the first depression structure R1. The first protrusion structure P1 is configured to position the optical unit. In this embodiment, the second surface S2 has a plurality of first protrusion structures P1 surrounding the first depression structure R1, and each of the first protrusion structures P1 has a longitudinal structure.

The second protrusion structure P2 protrudes outwardly from the second surface S2 and is adjacent to the first protrusion structure P1. The height of the first protrusion structure P1 protruding from the second surface S2 is greater than the height of the second protrusion structure P2 protruding from the second surface S2. The position of the second protrusion structure P2 corresponds to the position of the guiding assembly 400, so as to enhance the structural reliability of the optical member driving mechanism 10.

The third protrusion structure P3 protrudes outwardly from the second surface S2. The third protrusion structure P3 is situated at the edge of the base 120 and surrounds the second opening 121. The second protrusion structure P2 is disposed between the third protrusion structure P3 and the first protrusion structure P1, and the height of the third protrusion structure P3 protruding from the second surface S2 is greater than the height of the first protrusion structure P1 protruding from the second surface S2 and the height of second protrusion structure P2 protruding from the second surface S2. The second depression structure R2 is formed on the second surface S2, disposed between the second protrusion structure P2 and the third protrusion structure P3, and does not communicate with the first depression structure R1. The second depression structure R2 is configured to receive an electronic member E1 of the optical member driving mechanism 10 (such as a control IC, a sensor, or a connecting terminal).

The fourth protrusion structure P4 protrudes outwardly from the second surface S4, and its position corresponds to the position of the driving assembly 300. The height of the fourth protrusion structure P4 protruding from the second surface S2 is greater than the height of the third protrusion structure P3 protruding from the second surface S2. The transferring member 330 of the driving assembly 300 can enter the fourth protrusion structure P4. Therefore, as observed along a direction that is parallel to the second surface S2, the driving assembly 300 overlaps the second surface S2, and further overlaps the first protrusion structure P1, the second protrusion structure P2, and the third protrusion structure P3. The miniaturization of the optical member driving mechanism 10 can be achieved.

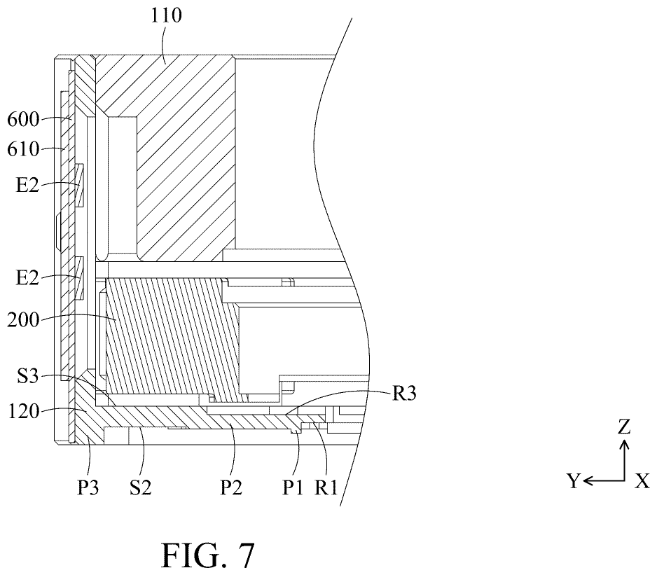

Referring to FIG. 7, in this embodiment, the base 120 has a third surface S3, and the third surface S3 and the second surface S2 face the opposite directions. A third depression structure R3 can be formed on the third surface S3, and the position of the third depression structure R3 corresponds to the position of the movable portion 200 or the optical member 30. As observed along a direction that is perpendicular to the third surface S3 the third depression structure R3 overlaps the first protrusion structure P1 and the second protrusion structure P2.

Referring to FIG. 3 to FIG. 5, the guiding assembly 400 includes a first guiding member 410 and a second guiding member 420. The first guiding member 410 can be affixed to the fixed portion 100 and pass through the movable portion 200, so that the movable portion 200 can be slidably connected to the first guiding member 410. The first guiding member 410 and the driving assembly 300 are disposed on the same side of the optical member driving mechanism 10, and the first guiding member 410 is adjacent to the driving assembly 300.

Similarly, the second guiding member 420 can be affixed to the fixed portion 100 and pass through the movable portion 200, so that the movable portion 200 can be slidably connected to the second guiding member 420. As observed along the optical member driving mechanism 10, the second guiding member 420 and the driving assembly 300 are substantially disposed on the opposite corners of the optical member driving mechanism 10.

Owing to the first guiding member 410 and the second guiding member 420 of the guiding assembly 400, the movable portion 200 can be prevented from being inclined when the driving assembly 300 drives the movable portion 200 to move.

A third opening 122 and a fourth opening 123 are formed on the second surface S2 of the base 120 of the fixed portion 100 and respectively corresponds to the first guiding member 410 and the second guiding member 420. When the guiding assembly 400 is assembled, the first guiding member 410 and the second guiding member 420 can be firstly affixed to the frame 110 of the fixed portion 100. Subsequently, they can pass the movable portion 200 and respectively enters the third opening 122 and the fourth opening 123 of the base 120. Finally, the adhesive glue H can be filled into the third opening 122 and the fourth opening 123 to affix the first guiding member 410 and the second guiding member 420.

As shown in FIG. 3 and FIG. 5, in this embodiment, the optical member driving mechanism 10 further includes a magnetic member 800, disposed on the movable portion 200 and adjacent to the second guiding member 420. The first guiding member 410 and the second guiding member 420 have ferromagnetic material. Therefore, a magnetic attraction force is generated between the second guiding member 420 and the magnetic member 800. The movable portion 200 can be ensured that it is attached on the second guiding member 420 during the movement.

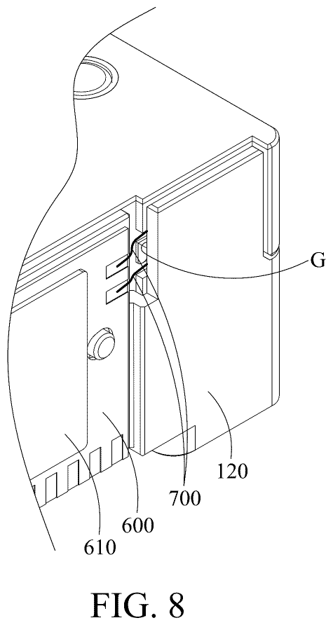

Referring to FIG. 2 and FIG. 8, in this embodiment, the optical member driving mechanism 10 further includes a circuit board 600 disposed on the outer surface of the base 120. A plurality of electronic members E2 can be disposed on the surface of the circuit board 600 facing the movable portion 200. A reinforcement plate 610 can be disposed on the surface of the circuit board 600 facing the movable portion 200 to prevent the circuit board 600 and/or the electronic members E2 from damaging during the assembly.

The circuit board 600 can be connected to the driving source 320 of the driving assembly 300 via the wires 700. As shown in FIG. 8, after the frame 110 and the base 120 of the fixed portion 100 are engaged, a gap G may be formed in the position adjacent to the circuit board 600. The wires 700 can pass the gap G to connect the circuit board 600 and the driving assembly 300.

In summary, an embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical member driving mechanism, comprising:
a movable portion, configured to connect an optical member;
a fixed portion, wherein the movable portion is movable relative to the fixed portion; and
a driving assembly, configured to drive the movable portion to move.

2. The optical member driving mechanism as claimed in claim 1, wherein the fixed portion comprises:
a first surface, facing a light-entering side;
a second surface, facing a light-exiting side;
a first opening, formed on the first surface; and
a second opening, formed on the second surface, wherein an optical axis passes through the first opening and the second opening,
the movable portion comprises a connecting surface, and the connecting surface faces the optical member,
the movable portion is movable relative to the fixed portion in a movement range, and when the movable portion is in a default position, the movable portion is disposed at the center of the movement range,
when the movable portion is in the default position, as observed along the optical axis, a shortest distance between the connecting surface and the first surface is different from a shortest distance between the connecting surface and the second surface.

3. The optical member driving mechanism as claimed in claim 2, wherein when the movable portion is in the default position, as observed along the optical axis, the shortest distance between the connecting surface and the first surface is greater than the shortest distance between the connecting surface and the second surface.

4. The optical member driving mechanism as claimed in claim 2, wherein the fixed portion comprises a base, the second surface is formed on the base, and the base comprises:
a first depression structure, formed on the second surface and configured to receive an optical unit;
a first protrusion structure, protruding outwardly from the second surface and adjacent to the first depression structure; and
a second protrusion structure, protruding outwardly from the second surface and adjacent to the first protrusion structure, wherein a height of the first protrusion structure protruding from the second surface is greater than a height of the second protrusion structure protruding from the second surface.

5. The optical member driving mechanism as claimed in claim 4, wherein the base further comprises a second depression structure, formed on the second surface and configured to receive an electronic member, wherein the second depression structure does not communicate with the first depression structure.

6. The optical member driving mechanism as claimed in claim 4, wherein the base further comprises a third protrusion structure protruding outwardly from the second surface, the third protrusion structure surrounds the second opening, and the second protrusion structure is disposed between the first protrusion structure and the third protrusion structure, wherein a height of the third protrusion structure protruding from the second surface is greater than a height of the second protrusion structure protruding from the second surface, and the height of the third protrusion structure protruding from the second surface is greater than a height of the first protrusion structure protruding from the second surface.

7. The optical member driving mechanism as claimed in claim 6, wherein:
as observed along a direction that is parallel to the second surface, the driving assembly overlaps the second surface,
as observed along the direction that is parallel to the second surface, the driving assembly overlaps the first protrusion structure,
as observed along the direction that is parallel to the second surface, the driving assembly overlaps the second protrusion structure,
as observed along the direction that is parallel to the second surface, the driving assembly overlaps the third protrusion structure.

8. The optical member driving mechanism as claimed in claim 4, wherein the base further comprises a fourth protrusion structure protruding outwardly from the second surface, and at least a portion of the driving assembly is disposed in the fourth protrusion structure.

9. The optical member driving mechanism as claimed in claim 4, wherein the base further comprises:
a third surface, wherein the third surface and the second surface face opposite directions; and
a third depression structure, formed on the third surface and corresponding to the movable portion or the optical member,
wherein as observed along a direction that is perpendicular to the third direction, the third depression structure overlaps the second protrusion structure,
wherein as observed along the direction that is perpendicular to the third direction, the third depression structure overlaps the first protrusion structure.

10. The optical member driving mechanism as claimed in claim 2, wherein the driving assembly comprises a driving source, the driving source is configured to generate a driving force, and as observed along a direction that is perpendicular to the optical axis, a shortest distance between the driving source and the first surface is less than a shortest distance between the driving source and the second surface.

11. The optical member driving mechanism as claimed in claim 10, wherein the driving assembly further comprises a transferring member, the transferring member is configured to transfer the driving force, and as observed along the direction that is perpendicular to the optical axis, the driving source is disposed between the transferring member and the first surface.

12. The optical member driving mechanism as claimed in claim 10, wherein the driving assembly further comprises an amplifying member, the amplifying member is configured to amplify the driving force, and as observed along the direction that is perpendicular to the optical axis, the amplifying member is disposed between the driving source and the first surface.

13. The optical member driving mechanism as claimed in claim 12, wherein the fixed portion comprises a fourth surface and a fifth surface, the fourth surface faces the driving assembly, the fifth surface faces the driving assembly, and the fourth surface and the fifth surface face different directions, wherein the driving assembly has a longitudinal structure, the fourth surface is not parallel to an extending direction of the longitudinal structure, and a shortest distance between the driving assembly and the fourth surface is different from a shortest distance between the driving assembly and the fifth surface.

14. The optical member driving mechanism as claimed in claim 13, wherein the shortest distance between the driving assembly and the fourth surface is less than the shortest distance between the driving assembly and the fifth surface, and the amplifying member is disposed between the fourth surface and the driving source.

15. The optical member driving mechanism as claimed in claim 14, wherein the shortest distance between the fifth surface and the driving assembly is greater than 0.15 millimeters.

16. The optical member driving mechanism as claimed in claim 12, wherein a relative density of the amplifying member is greater than a relative density of the fixed portion.

17. The optical member driving mechanism as claimed in claim 16, wherein the amplifying member comprises metal, the fixed portion comprises resin, and the relative density of the amplifying member is more than five times the relative density of the fixed portion.

18. The optical member driving mechanism as claimed in claim 12, wherein the optical member driving mechanism further comprises:
a first connecting member, disposed on the fourth surface and being in contact with the driving assembly; and
a second connecting member, disposed on the fifth surface and being in contact with the driving assembly, wherein a Young's modulus of the first connecting member is less than a Young's modulus of the fixed portion, and the Young's modulus of the first connecting member is less than a Young's modulus of the amplifying member.

19. The optical member driving mechanism as claimed in claim 2, wherein the optical member driving mechanism further comprises:
a first guiding member, connected to the fixed portion, wherein the movable portion is movably connected to the first guiding member; and
a second guiding member, connected to the fixed portion, wherein the movable portion is movably connected to the second guiding member,
wherein the fixed portion comprises a base, the base comprises a third opening and a fourth opening, the third opening is formed on the second surface and corresponds to the first guiding member, and the fourth opening is formed on the second surface and corresponds to the second guiding member.

20. The optical member driving mechanism as claimed in claim 2, wherein the fixed portion comprises a frame and a base, the frame and the base are engaged with each other, and the driving assembly is affixed to the frame, wherein the driving assembly comprises a circuit board and a wire, the circuit board is disposed on the base, and the wire passes through a gap between the frame and the base and connects to the circuit board and the driving assembly.
